(19) United States
(12) Patent Application Publication
(10) Pub. No.: US 2019/0019114 A1
(43) Pub. Date: Jan. 17, 2019

(54) REMOTE VEHICLE ACCESS AND MULTI-APPLICATION PROGRAM FOR CAR-SHARING

(71) Applicant: Lacus Technologies LLC, Brooklyn, NY (US)

(72) Inventor: Aleksey Medvedovskiy, Brooklyn, NY (US)

(21) Appl. No.: 16/032,495

(22) Filed: Jul. 11, 2018

Related U.S. Application Data
(60) Provisional application No. 62/531,611, filed on Jul. 12, 2017.

(51) Int. Cl. G06Q 10/02; G08G 1/00; G06Q 30/06; G01C 21/34

(52) U.S. Cl. CPC G06Q 10/02; G08G 1/20; G06Q 50/30; G01C 21/3438; G06Q 30/0645

(57) ABSTRACT

A system for facilitating electronic access to fleet vehicles, the system comprising a fleet manager system including information for one or more vehicles, and a vehicle reservation server communicatively coupled to the fleet manager system and the one or more vehicles over a communication network. The vehicle reservation server determines the one or more vehicles are within a given proximity to a client device and are available for rental based on the information from the fleet manager system, arranges rental of the determined one or more vehicles to the client device for a given period, enables remote access functions to the one or more vehicles for the client device during the rental, transmits details of the rental of the one or more vehicles to the fleet manager system, and communicates the remote access functions to the one or more vehicles in response to commands from the client device.

### CROSS REFERENCE TO RELATED APPLICATION

This application claims the priority of U.S. Provisional Application No. 62/531,611, entitled “REMOTE VEHICLE ACCESS AND MULTI-APPLICATION PROGRAM FOR CAR-SHARING,” filed on Jul. 12, 2017, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to a vehicle access system, and in particular, a rental vehicle access and management system in which vehicles are operated by remote computer signals.

### Description of the Related Art

Vehicle (e.g., automobile or car) owners generally invest significant amounts of time and money into an asset that they do not use all of the time. For example, automobiles are generally driven less than about 10% of the time, and are generally underutilized assets. Rental of such vehicles can allow for a more effective utilization of vehicles. As an example, a car sharing service can enable car owners to rent out their underutilized cars to a community of trusted drivers. This approach allows drivers to have access to a vehicle on demand, when needed, while requiring fewer cars by improving car utilization.

However, existing rental platforms are not suitable for transportation service vehicles such as limousines and taxicab vehicles that are managed as a fleet. Limousine and taxicab cars are usually assigned to drivers and dispatched to given locations. These vehicles are returned and parked at garage locations when drivers get off from their shifts. To generate extra income, fleet operators may desire to avail transportation service vehicles for rental to generate extra income which would otherwise sit idle in their garages. However, fleet garages are usually located in non-ideal locations and presents a hassle for potential renters.

There is this a need for a system to provide rental of transportation service vehicles from fleet operators without a live dispatcher, and view information of vehicles remotely online.

### SUMMARY OF THE INVENTION

The present invention provides a system and non-transitory computer-readable media for facilitating electronic access to fleet vehicles. According to one embodiment, the system comprises a fleet manager system including information for one or more vehicles, and a vehicle reservation server communicatively coupled to the fleet manager system and the one or more vehicles over a communication network. The vehicle reservation server receives the information for the one or more vehicles from the fleet manager system, determines the one or more vehicles are within a given proximity to a client device and are available for rental based on the information from the fleet manager system, arranges rental of the determined one or more vehicles to the client device for a given period, enables remote access functions to the one or more vehicles for the client device during the rental, transmits details of the rental of the one or more vehicles to the fleet manager system, and communicates the remote access functions to the one or more vehicles in response to commands from the client device.

The fleet manager system may further comprise an interface including a list of vehicles associated with the fleet manager system. The interface may include rental status for the list of vehicles. The interface may further include data for the list of vehicles including on-board diagnostics codes, breaking and throttle statistics, and location. Additionally, the interface may include information of trips, toll payments and transactions, tickets, and fare meter data.

In one embodiment, the vehicle reservation server is configured to generate a reservation start timer of a predetermined duration prior to the given period of the rental, wherein expiration of the reservation timer causes cancelation of the rental. The remote access may include instructions to lock and unlock doors, activate and deactivate an alarm, turn on and off headlights, and honk a horn. The one or more vehicles may be any one of yellow or green taxicabs, limousines, or black/ride-hailing vehicles.

According to one embodiment, the computer-readable media comprises computer program code for receiving information for one or more vehicles from a fleet manager system, computer program code for determining the one or more vehicles are within a given proximity to a client device and are available for rental based on the information from the fleet manager system, computer program code for arranging rental of the determined one or more vehicles to the client device for a given period, computer program code for enabling remote access functions to the one or more vehicles for the client device during the rental, computer program code for transmitting details of the rental of the one or more vehicles to the fleet manager system, and computer program code for communicating the remote access functions to the one or more vehicles in response to commands from the client device.

The fleet manager system may further comprise an interface including a list of vehicles associated with the fleet manager system. The interface may include rental status for the list of vehicles. The interface may further include data for the list of vehicles including on-board diagnostics codes, breaking and throttle statistics, and location. Additionally, the interface may include information of trips, toll payments and transactions, tickets, and fare meter data.

The non-transitory computer-readable media may further comprise computer program code for generating a reservation start timer of a predetermined duration prior to the given period of the rental, wherein expiration of the reservation timer causes cancelation of the rental. The remote access may include instructions to lock and unlock doors, activate and deactivate an alarm, turn on and off headlights, and honk a horn. The one or more vehicles may be any one of yellow or green taxicabs, limousines, or black/ride-hailing vehicles.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention;

FIG. 2 illustrates a flowchart of a method for managing vehicle rental according to an embodiment of the present invention;

FIG. 3 and FIG. 4 illustrate exemplary interfaces for listing vehicles available for rental on a client device according to an embodiment of the present invention;

FIG. 5 illustrates an exemplary interface for filtering vehicle options according to an embodiment of the present invention;

FIG. 6 and FIG. 7 illustrate exemplary reservation interfaces according to an embodiment of the present invention;

FIG. 8 and FIG. 9 illustrate exemplary interfaces for adding partner drivers to a reservation according to embodiment of the present invention;

FIG. 10 and FIG. 11 illustrate exemplary interfaces for users to view existing partnerships and pending partnership invitations according to an embodiment of the present invention;

FIG. 12 illustrates an exemplary interface for directing a user to a reserved vehicle according to an embodiment of the present invention;

FIG. 13 illustrates an exemplary active rental interface according to an embodiment of the present invention;

FIG. 14 illustrates exemplary features of a panic button according to an embodiment of the present invention;

FIG. 15 illustrates an exemplary payout and add funds interface according to an embodiment of the present invention;

FIG. 16 illustrates an exemplary interface for selecting types of payouts according to an embodiment of the present invention;

FIG. 17 illustrates an exemplary interface for selecting an amount to transfer from the available balance according to an embodiment of the present invention;

FIG. 18 illustrates an exemplary interface for adding funds to the available balance according to an embodiment of the present invention;

FIG. 19 illustrates an exemplary interface for displaying transactions according to an embodiment of the present invention;

FIG. 20 illustrates an exemplary tickets interface according to an embodiment of the present invention;

FIG. 21 illustrates an exemplary tollway interface according to an embodiment of the present invention;

FIG. 22 illustrates an exemplary reservation history overview interface according to an embodiment of the present invention;

FIG. 23A and FIG. 23B illustrate exemplary interfaces including a detailed overview and entire trip history of a given vehicle rental reservation according to an embodiment of the present invention; and

FIG. 24 illustrates an exemplary trip detail interface according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

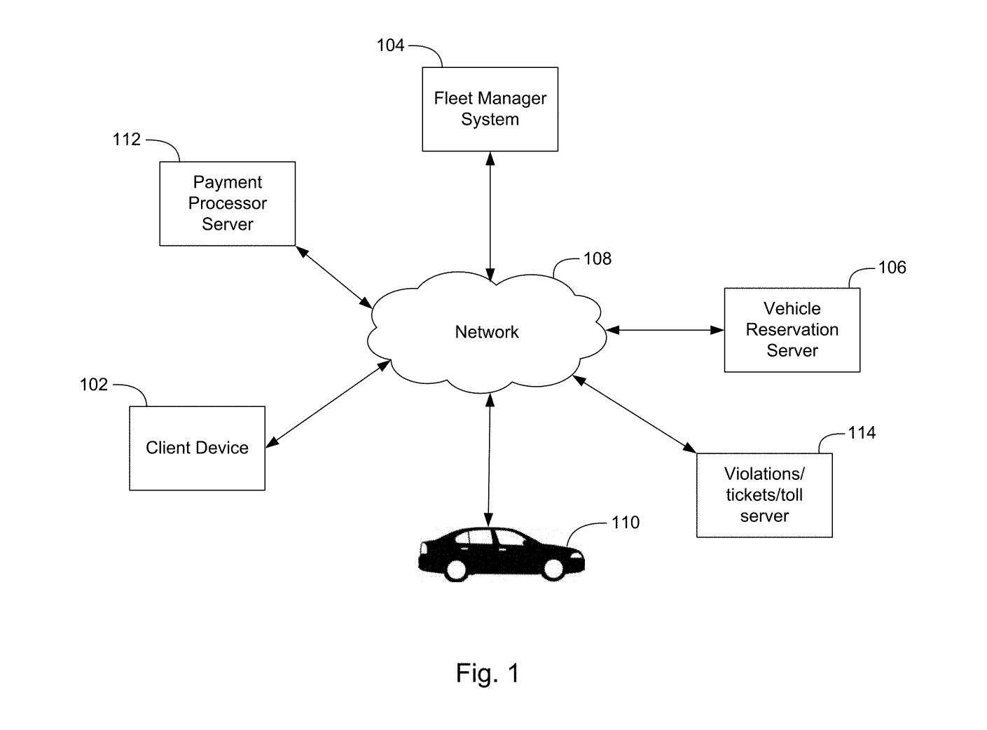

The presently disclosed system provides a vehicle management system for managing vehicles, such as taxicabs, fleet, or “car service” vehicles, for rental to driver users such as drive-for-hire professionals including bus, chauffeur, taxicab, limo, and commercial drivers. FIG. 1 illustrates a computing system according to an embodiment of the present invention. The system presented in FIG. 1 includes client device 102, fleet manager system 104, vehicle reservation server 106, network 108, vehicle 110, and payment processor server 112. Vehicle reservation server is operative to communicate with client device 102, fleet manager system 104, and vehicle 110 across the network 108. Fleet manager system 104 may comprise any computing device having a central processing unit and memory unit, such as, a desktop, notebook, or tablet computers, smartphones, etc. A fleet manager system 104 (or a plurality thereof) may subscribe to vehicle reservation server 106 to enable rental of vehicles managed by the fleet manager system 104. In one embodiment, fleet manager system 104 may upload or transmit an inventory or information of vehicles, such as taxicabs, limousine, or livery vehicles that are owned and licensed by the fleet owner to the vehicle reservation server 106. The vehicle information may include vehicle availability or status, vehicle details (e.g., make, year, model, color, mileage, VIN (vehicle identification number), vehicle type, etc.), and location.

Fleet manager system 104 may include and execute software configured to manage vehicle reservations/rental, and maintenance for an inventory of vehicles in conjunction with vehicle reservation server 106. A user of fleet manager system 104 may include an interface that allows a fleet operator to view and manage a list of vehicles belonging to the his/her fleet, view reservation/rental status of those vehicles (e.g., available, offline, pending, reserved), and read data from the vehicles, such as, on-board diagnostics (OBD) codes, and breaking/throttle statistics. Vehicle reservation server 106 and/or fleet manager system 104 may be configured to communicate with, monitor, or receive data from vehicle 110, such as by installing a computing or tracking device on vehicle 110. The user of fleet manager system 104 can also use the interface to retrieve and view where each vehicle was picked up and dropped off through the vehicle reservation server 106. Fleet manager system 104 may further retrieve information of trips, toll payments/EZ pass transactions, tickets, and fare meter data of vehicles. According to one embodiment, fleet manager system 104 may block certain drivers from renting their vehicles through vehicle reservation server 106. Fleet manager system 104 may also be configured to generate periodic reports, such as daily, monthly, or annual earnings from vehicles, via call, text, email, etc.

Vehicle information including the status and location of the fleet manager's vehicles for rental may be communicated between fleet manager system 104 and vehicle reservation server 106 over network 108. Vehicle reservation server 106 may be configured to provide driver users on client device 102 with locations of vehicles for rental based on the vehicle information. In one embodiment, the fleet manager may disperse the vehicles to a plurality of areas. For example, given portions of the fleet manager's vehicles available for rental may be parked and located at various neighborhood locations. A driver user may use client device 102 to locate the vehicles for rental through a connection to vehicle reservation server 106 over network 108. For example, a map and/or a list of available vehicles within a given proximity of the user's current location via client device 102 (e.g., obtained by global positioning system (GPS)) may be provided by the vehicle reservation server 106.

Prior to reserving an available vehicle, the user may register and validate with the vehicle reservation server 106. The vehicle reservation server 106 may register and validate users by requesting certain information such as license number, a copy of a regulatory agency (that has regulatory authority over ground transportation, such as, a taxicab and limousine commission) license and a picture of themselves. Valid information provided by the user may be stored into a database of registered users. Once validated, a user may reserve any available vehicle for rental through vehicle reservation server 106. A user may reserve, for example, vehicle 110, for rental at a certain rate and duration. Vehicle reservation server 106 may facilitate and create a rental contract between the user of client device 102 and fleet manager system 104 to operate vehicle 110 based on the reservation. Details of the rental contract may be transmitted to fleet manager 104 from vehicle reservation server 106 and the status of vehicle 110 may be updated for fleet manager 104.

According to one embodiment, a reservation timer of a predetermined duration, for example, a grace period of 30 minutes, may be given to the user to reach and/or start rental of the reserved vehicle 110. If the timer runs out before the user is able to reach or start rental of vehicle 110, the reservation of the vehicle will end, and rental of vehicle 110 may be canceled, and as such, vehicle 110 may be made available for other users to reserve for rental.

Upon reaching vehicle 110, the user may use client device 102 to gain entry to reserved vehicle 110 by sending a command or request to the vehicle reservation server 106. Successful access to the reserved vehicle 110 allows the user to use the vehicle for the duration of rental. According to one embodiment, vehicle 110 may include hardware that is communicatively connected to vehicle reservation server 106 and/or fleet manager system 104 over network 108 to remotely control or access certain operations of vehicle 110 such as locking/unlocking doors, activate/deactivate alarm, turning on/off headlights, honking a horn, etc. The vehicle reservation server 106 may communicate with hardware in the vehicle 110 to unlock the vehicle 110. The hardware in vehicle 110 may also include a tracking device that allows vehicle reservation server 106 and fleet manager system 104 to determine the location of vehicle 110.

Fleet manager system 104 and/or vehicle 110 may be communicatively connected to payment processor server 112 over network 108 to process payments. For example, fare payments and crediting of the fare payments to the user may be processed through payment processor server 112. Payment processor server 112 may comprise credit card, bank and direct debt payment, mobile wallets, and cryptocurrency payment systems. Upon the end of a reservation, the user may be directed to park the vehicle 110 at an immediate location or as specified by vehicle reservation system 106 such that the vehicle 110 may be available for another rental. Violations/tickets/toll server 114 is representative of a plurality of servers that may be used to retrieve traffic tickets, summonses, fines, and toll information for vehicle 110 to assess against the user's account.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like.

Network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices may be encrypted using, for example, the Advanced Encryption Standard (AES) with a 256-bit key size, or any other encryption standard known in the art.

Client device 102 may comprise computing devices (e.g., smartphones, notebook and tablet computers, e-book readers, smart watches and wearable devices, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. A client device may also include or execute an application to communicate content, such as, for example, textual content, multimedia content, or the like. A client device may also include or execute an application to perform a variety of possible tasks, such as browsing, searching.

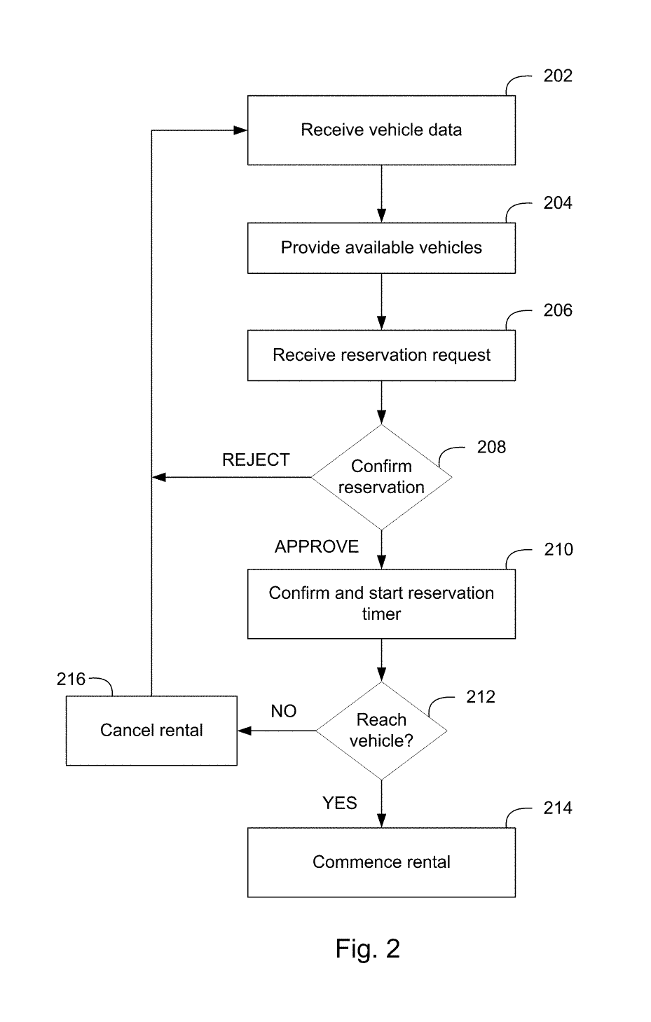

FIG. 2 presents a flowchart of a method for managing vehicle rental according to an embodiment of the present invention. A reservation server may be accessed from a driver software application executed on client devices to reserve and rent vehicles from third party fleet managers and owners. Vehicle information is received by the reservation server, step 202. The vehicle information may be received from one or more fleet manager systems. The vehicle information may include vehicle availability or status, vehicle details (e.g., make, year, model, color, mileage, VIN, vehicle type, etc.), and location.

Available vehicles that can be reserved are provided, step 204. The available vehicles may be determined from the vehicle information provided by the fleet manager systems. The reservation server may further receive location data of a client device to determine available vehicles in proximity to the client device. The available vehicles may be provided on a map and/or list on the driver software application executed on the client device. A user of the client device may view and select a vehicle to reserve for rental.

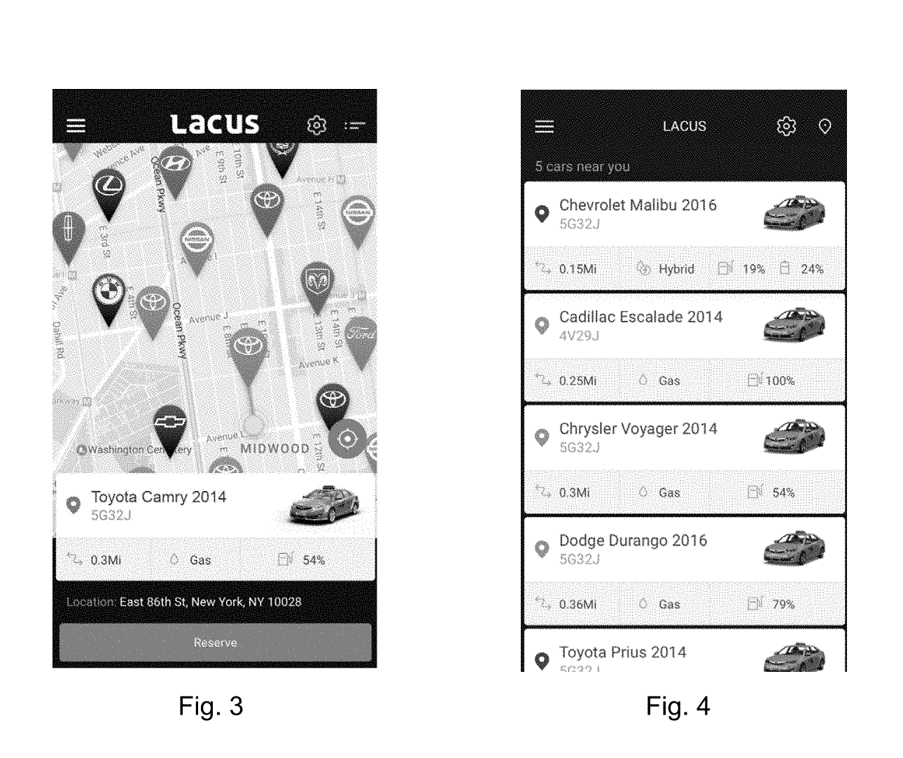

FIG. 3 and FIG. 4 present exemplary interfaces for listing vehicles available for rental on a client device according to an embodiment of the present invention. FIG. 3 includes a map view that displays markers with vehicle make symbols and color according to vehicle classification. For example, a user/driver may choose between yellow or green taxicabs, limousines, and black/ride-hailing vehicles. The interfaces may provide a list of years, makes and models, and fuel type (e.g., hybrid, gas, or electric) of the available vehicles. Other information associated with the vehicles may also be provided, such as, remaining gas in the tank, how far vehicle is located from the requesting user and exact address of the vehicle, and OBD II codes or data. Vehicle information may be gathered live from servers (reservation server or fleet manager system) and used to refresh the interface on the client device. If a user prefers not to browse through a map view, the user can switch to a list view, as illustrated in FIG. 4.

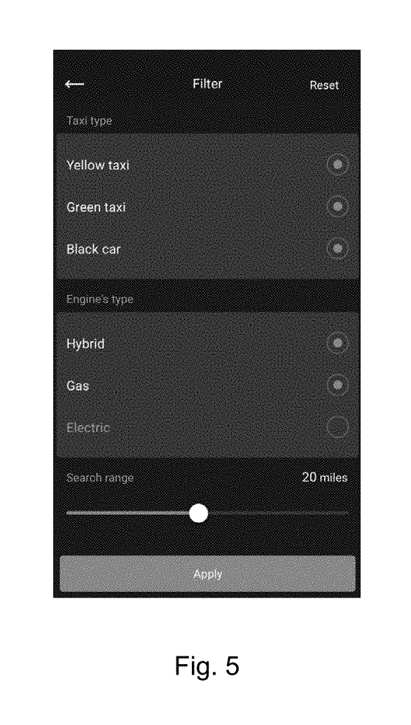

FIG. 5 presents an exemplary interface for filtering vehicle options according to an embodiment of the present invention. The user may filter a specific vehicle classification (e.g., yellow or green taxicabs, limousines, and black/ride-hailing vehicles), engine type (e.g., hybrid, gas, or electric). Search range or proximity of vehicle to the user can also be modified.

Referring back to FIG. 2, a reservation request is received from a client device, step 206. The reservation request may include an account number, a vehicle identifier, duration of rental, payment information (including price and payment method), and driver information. The reservation server may confirm the details of the reservation request, step 208. If rejected, the method may return to step 202. Upon approval of the reservation request, the user of the request may be given a grace period, for example, 30 minutes to arrive at the reserved vehicle. The reservation server starts a reservation timer, step 210.

During the reservation timer, the reservation server monitors whether the user has reached and requested to start rental of the reserved vehicle, step 212. A user may indicate to the reservation server that he/she has arrived at the reserved vehicle by sending a command or request from the driver software application to start the rental. If the user reaches the reserved vehicle before expiration of the reservation timer, rental of the vehicle is allowed to commence by the reservation server and charge the account of the user, step 214. To access the reserved vehicle, i.e., unlock the doors, the user may send a request to the reservation server through the driver software application. However, failure to reach and access the vehicle before expiration of the reservation timer causes the reservation server to cancel rental of the reserved vehicle, step 216. Cancelation of the rental also disables access to the vehicle.

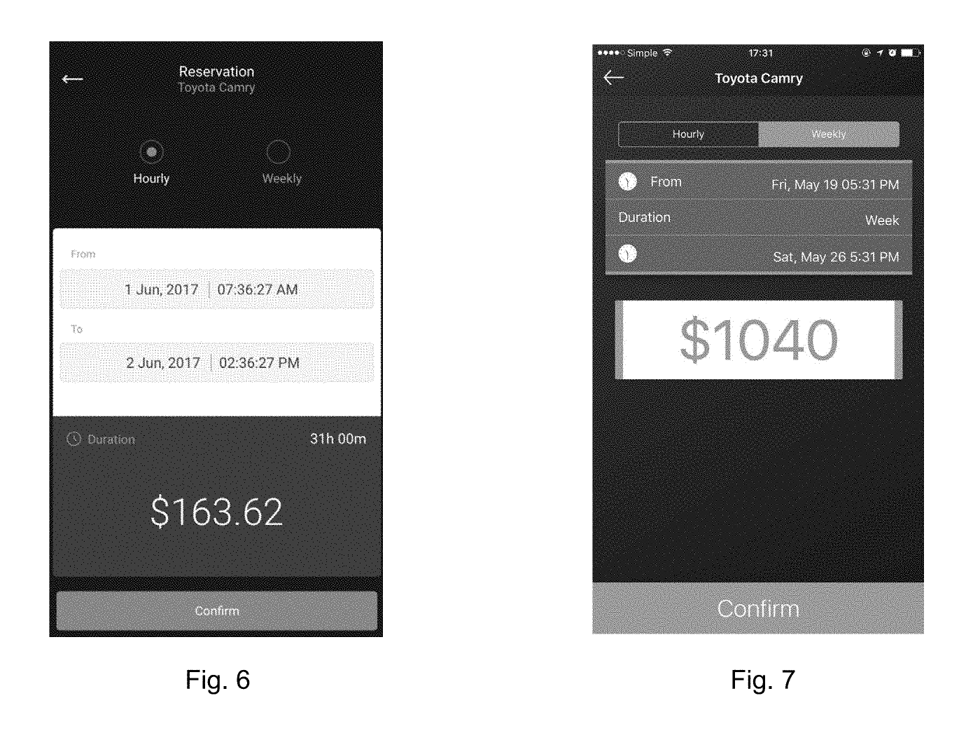

FIG. 6 and FIG. 7 present exemplary reservation interfaces according to an embodiment of the present invention. The user may switch between hourly and weekly rental and receive a most optimal price for both options. A price for the rental may be displayed based on a given rental rate and period. Prices for hourly rental may be based on a 12-hour shift (e.g., day 5 am-5 pm, night 5 pm-5 am). For example, hourly price may be calculated using a regulatory authority allowed cap price plus sales tax plus credit card processing fees, then divided in 12 hours and multiplied by the number of hours left to the end of each shift. Pricing may also be adjusted and modified according to certain user criteria and vehicle usage.

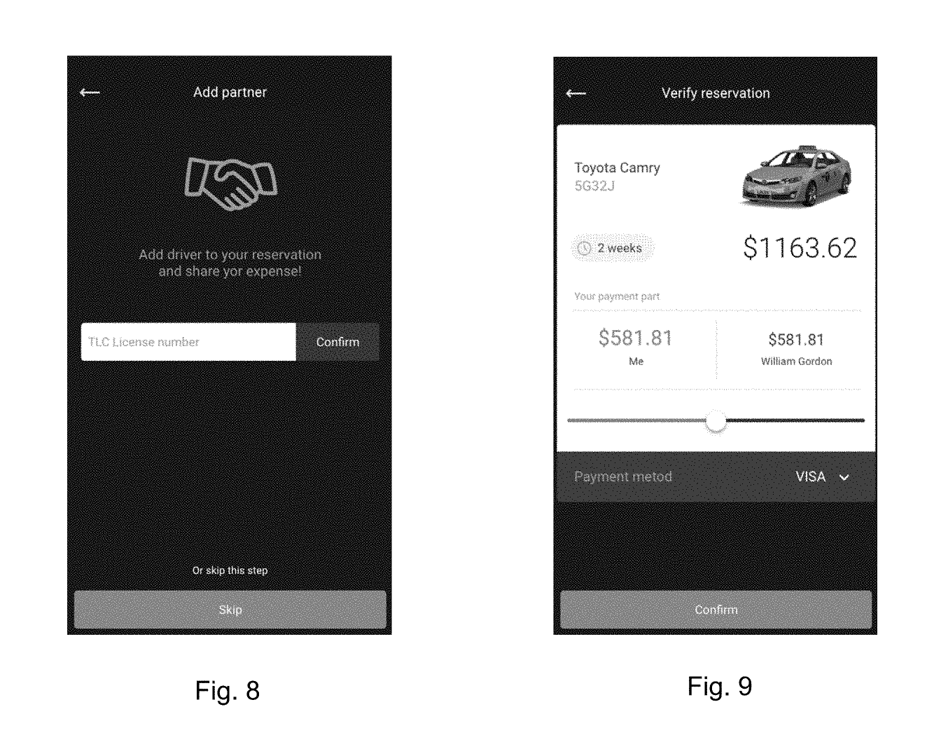

In most cases, the user is the sole driver of the rented vehicle. However, according to one embodiment, users can share weekly rental cost with one or more partners of his/her choice. FIG. 8 presents an interface for adding partner drivers to a reservation according to embodiment of the present invention. The user may add drivers from a database of registered users (reservation server) by providing a regulatory authority license number to retrieve a driver from the database. The user may further be provided with an option to variably split the costs of a rental session between two drivers (e.g., via a slider, or numerical input), as illustrated in FIG. 9.

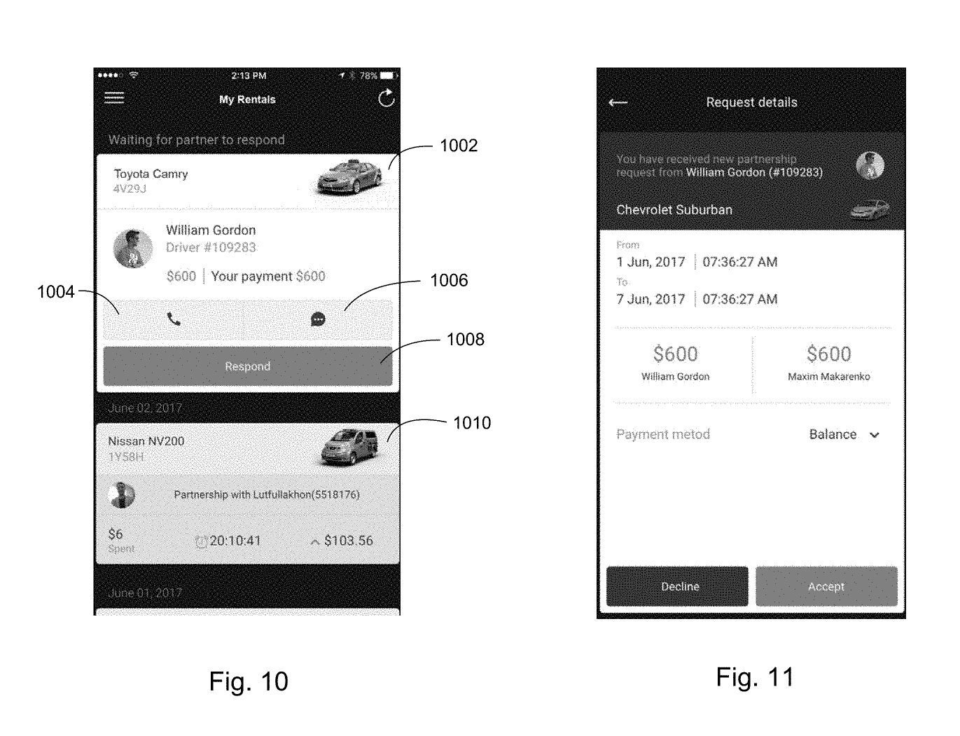

FIG. 10 presents an exemplary interface for users to view existing partnerships (such as 1010) and pending partnership invitations (such as 1002) according to an embodiment of the present invention. A partner driver added to a reservation may receive a pending partnership invitation 1002. The invitation may allow the partner driver to contact the inviter via voice call 1004 or short message service (SMS) 1006. The partner driver may select respond 1008 to view reservation details (e.g., vehicle, rental period, and cost share), choose payment method, and approve or decline the invitation, as shown in FIG. 11. After approval, a partnered reservation, both drivers may have equal access to rental information and access for the reserved vehicle.

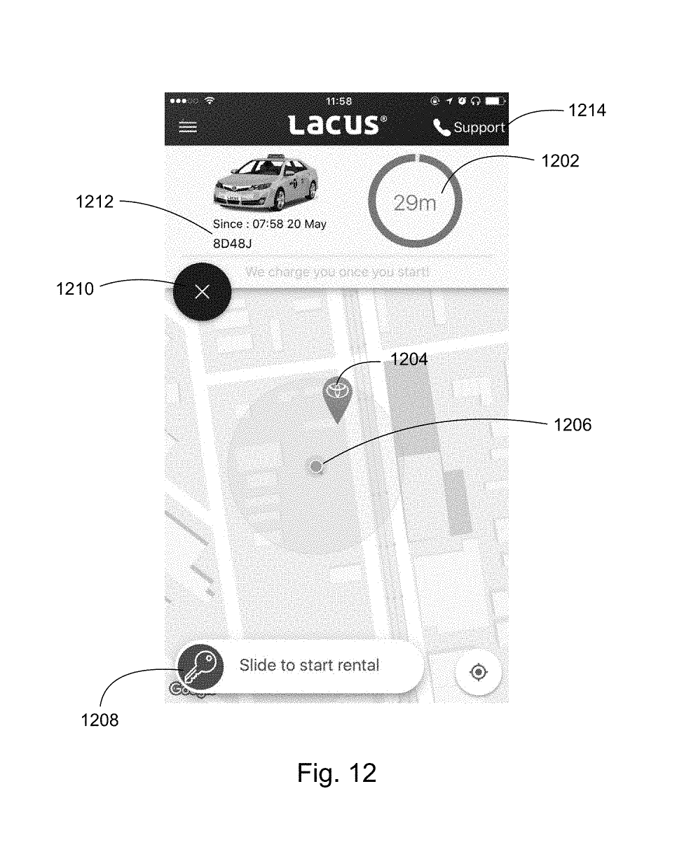

FIG. 12 presents an exemplary interface for directing a user to a reserved vehicle after confirmation according to an embodiment of the present invention. The user is presented with a remaining reservation time 1202 to start the reservation. Identifier information 1212 of the reserved vehicle, such as, license plate number, and other details may be provided to the user to help the user locate the reserved vehicle. Additionally, the user may be presented with navigation to vehicle 1204 based on the location of user 1206. The user may also call customer support 1214 if additional assistance is needed. Upon reaching the vehicle, the user may slide button 1208 start the rental of the vehicle. The user may also select button 1210 to cancel reservation of the vehicle.

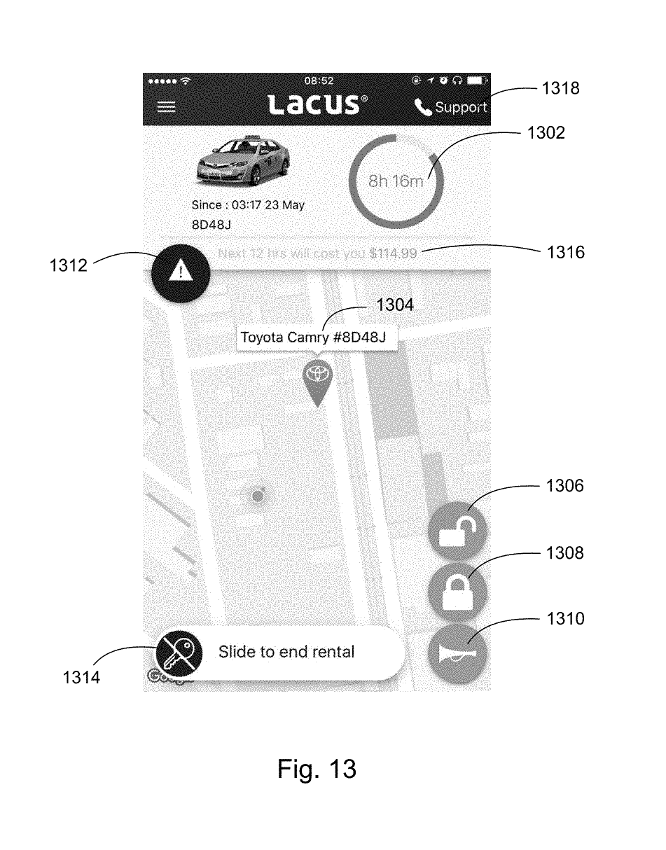

FIG. 13 presents an exemplary active rental interface according to an embodiment of the present invention. Once the rental is started, a user may be provided with access to the vehicle's control features. A user may locate a vehicle 1304, unlock doors 1306, lock doors 1308, and trigger horn 1310. The user may be presented with a time remaining (e.g., of shift) 1302 and a price 1316 for a next 12 hours (e.g., next shift). The user may call customer support 1318 if additional assistance is needed. Button 1314 may be used to end the rental session. The active rental interface also includes panic button 1312 to report issues.

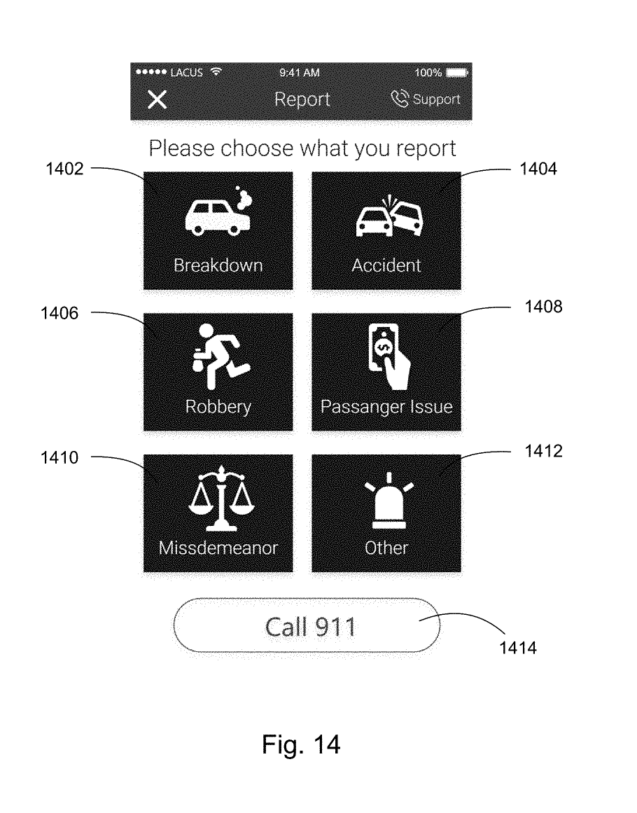

FIG. 14 presents exemplary features of a panic button according to an embodiment of the present invention. An incident or an accident whether inside the vehicle or crime on the streets can be reported directly to police or a fleet by pressing the panic button. Examples include vehicle breakdown 1402, motor vehicle accident 1404, robbery 1406, issue with a passenger 1408, misdemeanor 1410 (that user became a witness of), and other incidents 1412. Additionally, the panic button may provide a shortcut to call 911 (1414).

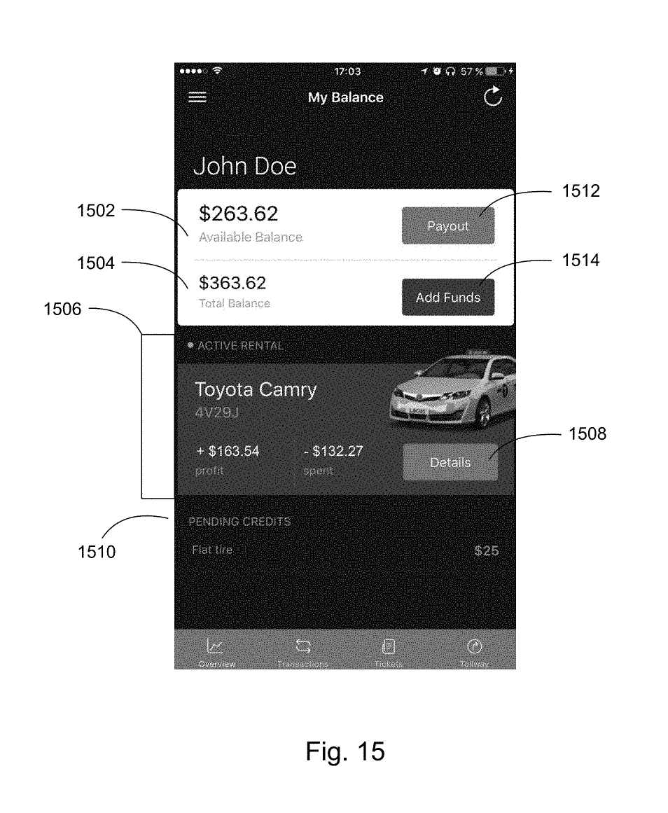

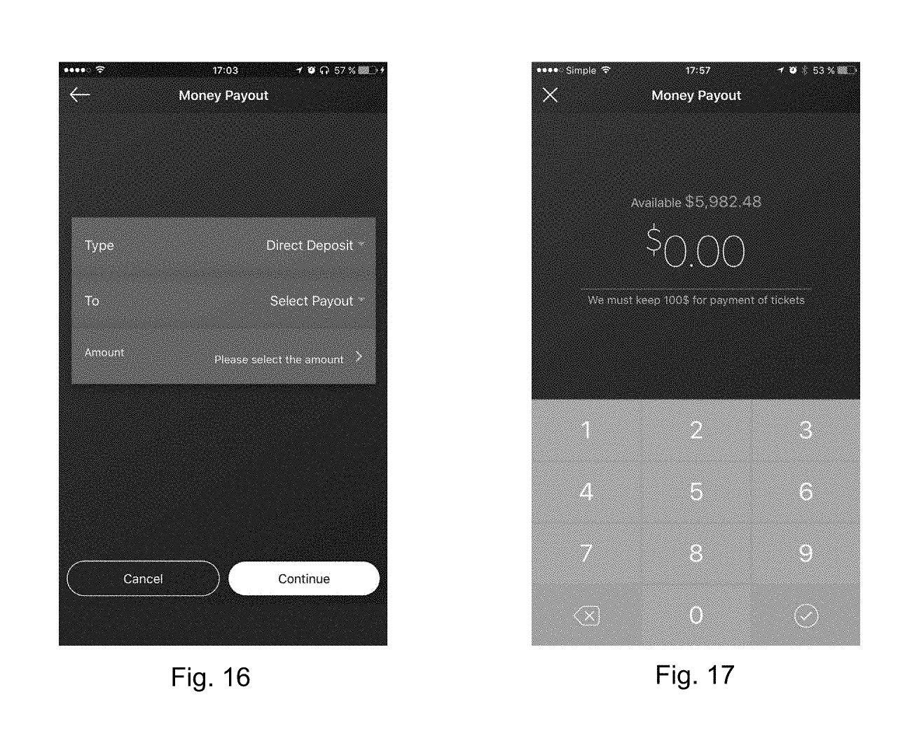

FIG. 15 presents an exemplary payout and add funds interface where a user can access their balance page according to an embodiment of the present invention. The user can see available balance 1502, see total balance 1504, see an active rental with statistics of the earnings 1506, go to active reservation details 1508, see pending credits 1510, withdraw funds from an available balance (Payout 1512), and add money to the available balance (Add Funds 1514). The available balance may be accumulated from a collection of payments and credits minus tolls, violations, and expenses, etc., for providing driving services using the rented vehicle. Payout 1512 may be selected to present an interface for selecting types of payouts for withdrawing funds from the available balance, such as the exemplary interface illustrated in FIG. 16. To withdraw funds from the available balance, the user may select a payment method such as automatic clearing house (ACH) or wire transfer along with an account number and an amount to transfer to the account. FIG. 17 presents an exemplary interface for selecting an amount to transfer from the available balance. The available balance may be displayed to indicate how much the user can withdraw. According to the illustrated embodiment, the system may hold a predetermined amount of money on the user's account that won't be released to the user for 30 days after the last reservation. This is a way an owner of the rented vehicle may limit themselves from losing money on parking violations, camera and moving violation summonses.

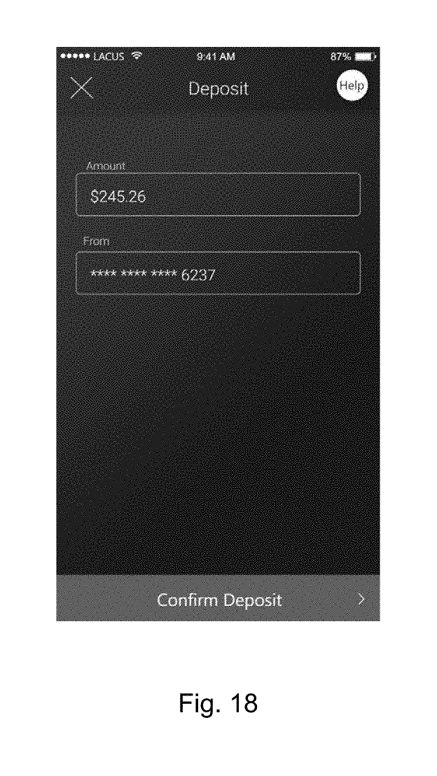

FIG. 18 presents an exemplary interface for adding funds to the available balance according to an embodiment of the present invention. The user may add funds for his account in the case that the available balance is $0 or falls below a minimum required for a vehicle rental. A user can choose an amount to deposit to the available balance, select a payment method (e.g., ACH, wire transfer, credit cards or debit cards).

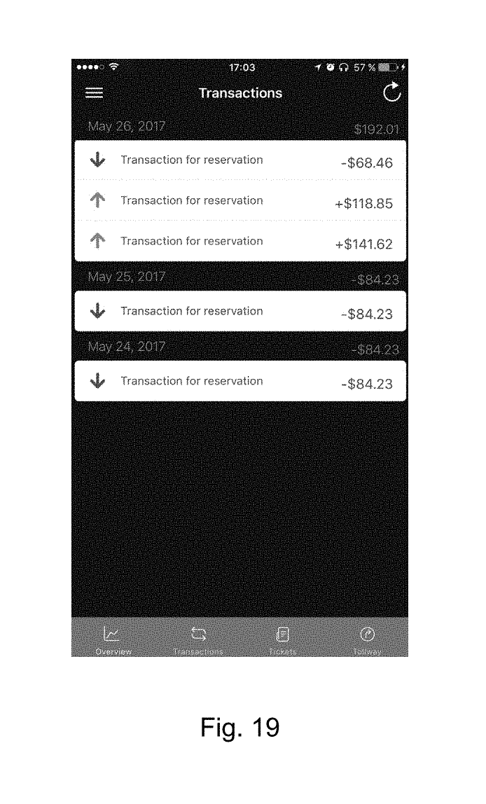

FIG. 19 presents an exemplary interface for displaying transactions such as charges for reservations, incoming credit card transactions, deposits, withdrawals, as well as unsuccessful transactions (e.g., not approved, doesn't go through, chargeback, etc.).

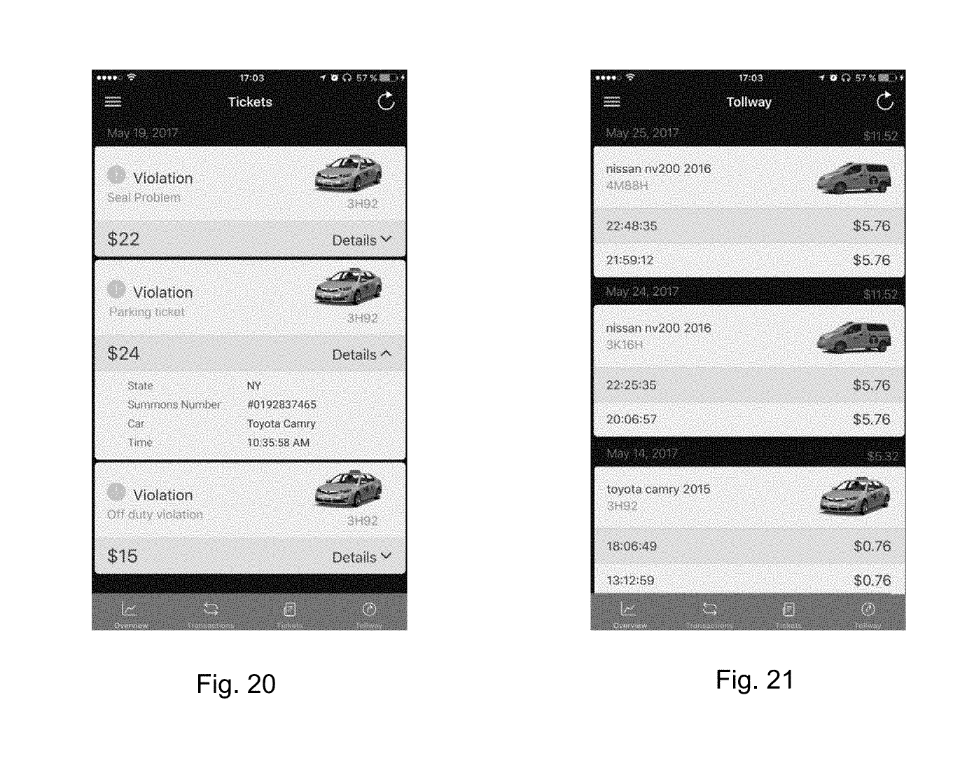

FIG. 20 presents an exemplary tickets interface according to an embodiment of the present invention. The tickets interface is operable to display the details of tickets or summons. For example, in the event a user receives summons(es) for whatever reason and is deemed to be in fault, such a summons(es) will be added to the user's account and funds will be withdrawn from the user's account balance automatically. The owner of the rented vehicle (e.g., fleet owner) may be given the ability to decide if such summons(es) are withdrawn from the user's account. Summons information in the tickets interface may be retrieved by the reservation server from a municipality, city, or other government entity websites.

FIG. 21 an exemplary tollway interface according to an embodiment of the present invention. The tollway interface is operable to display tollway activity. The tollway activity includes tollway transactions gathered by the reservation server from, for example, E-ZPass or port authority databases or websites. Using the tollway interface, a user may view tollway transactions that were made under a reservation with details such as: name of toll plaza, tunnel or bridge, and amount of transaction along with time of transaction.

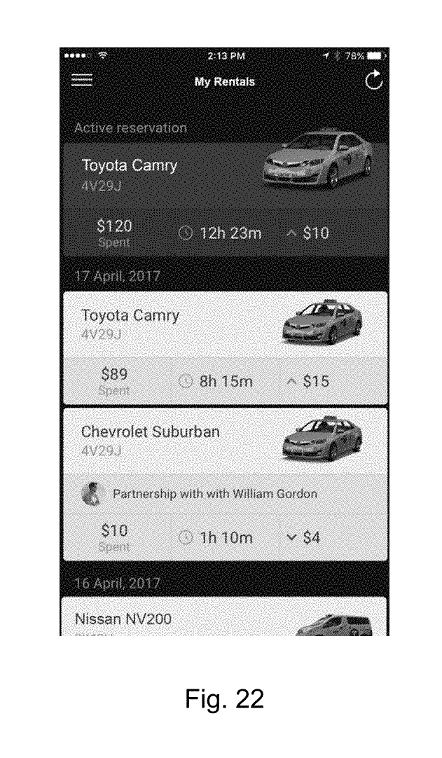

FIG. 22 presents an exemplary reservation history overview interface according to one embodiment. A brief overview of one or more rental reservations may be sorted in chronological order and displayed with details such as: vehicle information, rental cost, hours/duration, and partner, if any. An active reservation may be displayed on top of the page, as depicted in the illustrated embodiment. Each of the reservations may be selected to provide a detailed overview.

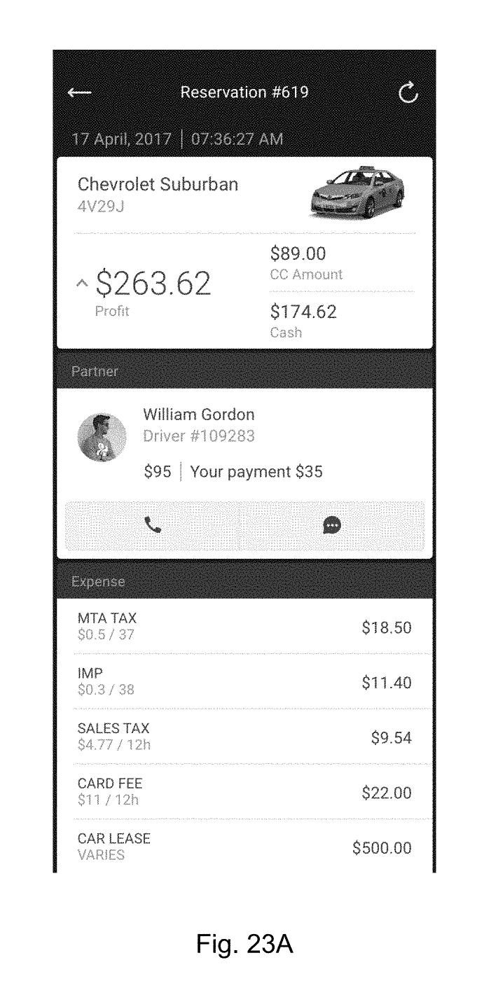

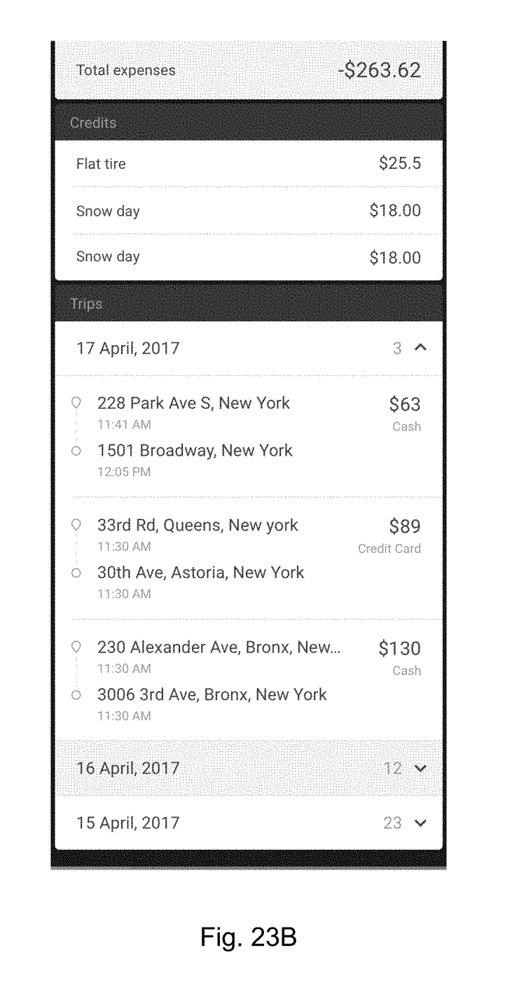

FIG. 23A and FIG. 23B present an exemplary interface including a detailed overview and entire trip history of a given vehicle rental reservation. A user may be provided with detailed explanation and breakdown of a specific reservation including expenses, credits, and trip history. For example, the interface may include basic information about: rental cost, additional charges that are charged above rental cost (taxes, fees, tollways, etc.), credits (credits issued to the driver by a fleet for any reason), driver's gross/net profits, detailed trip sheet with time and address of pick-up and drop-off locations. Each trip may also be selected to present a detailed display of a trip.

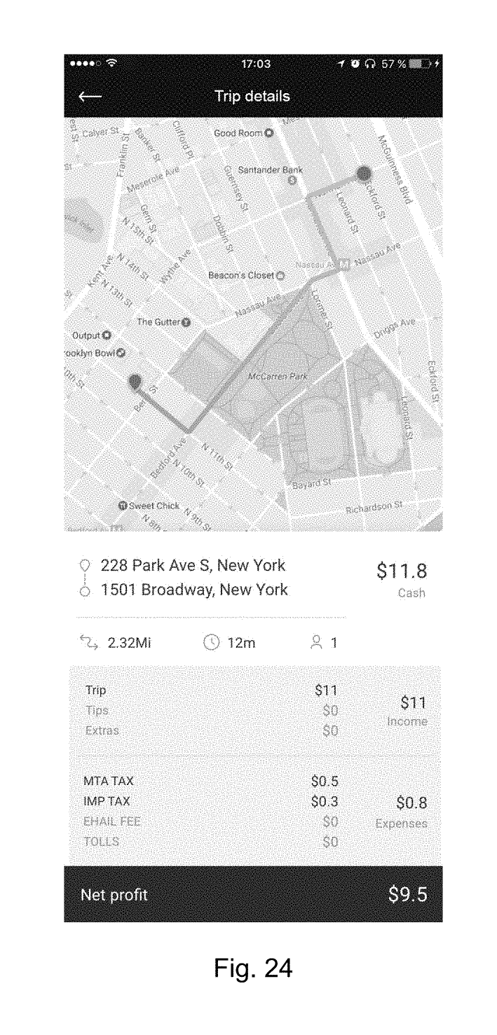

FIG. 24 presents an exemplary trip detail interface according to an embodiment of the present invention. The trip detail interface may display comprehensive information about the trip, such as, trip income and expense breakdown, pick-up and drop-off locations, pick-up and drop-off time, trip length, payment type: cash or credit, and a trip map.

FIGS. 1 through 24 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for facilitating electronic access to fleet vehicles, the system comprising:
a fleet manager system including information for one or more vehicles; and
a vehicle reservation server communicatively coupled to the fleet manager system and the one or more vehicles over a communication network, the vehicle reservation server:
receives the information for the one or more vehicles from the fleet manager system,
determines the one or more vehicles are within a given proximity to a client device and are available for rental based on the information from the fleet manager system,
arranges rental of the determined one or more vehicles to the client device for a given period,
enables remote access functions to the one or more vehicles for the client device during the rental,
transmits details of the rental of the one or more vehicles to the fleet manager system, and
communicates the remote access functions to the one or more vehicles in response to commands from the client device.

2. The system of claim 1 wherein the fleet manager system further comprises an interface including a list of vehicles associated with the fleet manager system.

3. The system of claim 2 wherein the interface further includes rental status for the list of vehicles.

4. The system of claim 2 wherein the interface further includes data for the list of vehicles including on-board diagnostics codes, breaking and throttle statistics, and location.

5. The system of claim 2 wherein the interface further includes information of trips, toll payments and transactions, tickets, and fare meter data.

6. The system of claim 1 wherein the vehicle reservation server is configured to generate a reservation start timer of a predetermined duration prior to the given period of the rental, wherein expiration of the reservation timer causes cancelation of the rental.

7. The system of claim 1 wherein the remote access includes instructions to lock and unlock doors, activate and deactivate an alarm, turn on and off headlights, and honk a horn.

8. The system of claim 1 wherein the one or more vehicles are at least one of yellow or green taxicabs, limousines, or black/ride-hailing vehicles.

9. Non-transitory computer-readable media comprising program code that when executed by a programmable processor causes execution of a method for facilitating electronic access to fleet vehicles, the computer-readable media comprising:
computer program code for receiving information for one or more vehicles from a fleet manager system,
computer program code for determining the one or more vehicles are within a given proximity to a client device and are available for rental based on the information from the fleet manager system,
computer program code for arranging rental of the determined one or more vehicles to the client device for a given period,
computer program code for enabling remote access functions to the one or more vehicles for the client device during the rental,
computer program code for transmitting details of the rental of the one or more vehicles to the fleet manager system, and
computer program code for communicating the remote access functions to the one or more vehicles in response to commands from the client device.

10. The non-transitory computer-readable media of claim 9 wherein the fleet manager system further comprises an interface including a list of vehicles associated with the fleet manager system.

11. The non-transitory computer-readable media of claim 10 wherein the interface further includes rental status for the list of vehicles.

12. The non-transitory computer-readable media of claim 10 wherein the interface further includes data for the list of vehicles including on-board diagnostics codes, breaking and throttle statistics, and location.

13. The non-transitory computer-readable media of claim 10 wherein the interface further includes information of trips, toll payments and transactions, tickets, and fare meter data.

14. The non-transitory computer-readable media of claim 9 further comprising computer program code for generating a reservation start timer of a predetermined duration prior to the given period of the rental, wherein expiration of the reservation timer causes cancelation of the rental.

15. The non-transitory computer-readable media of claim 9 wherein the remote access includes instructions to lock and unlock doors, activate and deactivate an alarm, turn on and off headlights, and honk a horn.

16. The non-transitory computer-readable media of claim 9 wherein the one or more vehicles are at least one of yellow or green taxicabs, limousines, or black/ride-hailing vehicles.
